(19) United States
(12) Patent Application Publication
(10) Pub. No.: US 2019/0122240 A1
(43) Pub. Date: Apr. 25, 2019

(54) MEDIA DEPLOYMENT SYSTEM, METHOD AND APPARATUS

(71) Applicant: Steve Haase, Los Angeles, CA (US)

(72) Inventor: Steve Haase, Los Angeles, CA (US)

(21) Appl. No.: 16/169,468

(22) Filed: Oct. 24, 2018

Related U.S. Application Data
(60) Provisional application No. 62/576,548, filed on Oct. 24, 2017.

(51) Int. Cl. G06Q 30/02; G06F 17/22; G06T 19/00

(52) U.S. Cl. CPC G06Q 30/0209; G06T 19/006; G06F 17/2235

(57) ABSTRACT

Aspects of the present disclosure include systems, apparatuses and methods of instituting a media deployment and tracking system. The system may also manage and allocate donations to recipients based on the media deployed and the interactions tracked. The system may also provide rewards to participants for performing the interactions.

### CROSS-REFERENCE TO RELATED APPLICATIONS

This application claims the benefit of U.S. Provisional Patent Application No. 62/576,548, filed Oct. 24, 2017, the entire contents of which is hereby fully incorporated herein by reference for all purposes.

### FIELD OF THE INVENTION

The field of the current invention generally regards systems and methods for deploying and tracking online media. In particular, the current invention pertains to systems and methods for allocating donations and rewards based on the interaction between users and online media.

### COPYRIGHT STATEMENT

This patent document contains material subject to copyright protection. The copyright owner has no objection to the reproduction of this patent document or any related materials in the files of the United States Patent and Trademark Office, but otherwise reserves all copyrights whatsoever.

### BACKGROUND OF THE INVENTION

Online attention span has been found to be approximately 8 seconds for Gen Y and 2.8 seconds for Gen Z, making it increasingly difficult for content creators and marketers to capture engagement. Further, brands and corporations who are making large donations to nonprofits have limited ways of capturing and measuring the positive return on investment they receive from their generous donations.

Accordingly, there is a need for a media system and method of content engagement that motivates users to engage, gives potential brand sponsors a real way to capture and measure the positive brand impact they may receive from their donations, that educates the public regarding the causes, and that spreads the word throughout the community, or even the world, regarding the benefits of cause related efforts.

### SUMMARY OF THE INVENTION

The present invention is specified in the claims as well as in the below description.

In one embodiment, a computing system may comprise at least one processor unit; at least one memory unit coupled with the at least one processor unit; computer readable instructions embodied in the memory unit and executable by the processor unit, wherein execution of the instructions by the processor unit causes the computing system to perform a method, the method comprising: (A) receiving information related to at least one unallocated donation; (B) receiving information related to a first recipient; (C) providing media over a network; (D) receiving information related to a first user's interaction with the provided media in (C); and (E) allocating, based on the information received in (D), at least a portion of the at least one unallocated donation to the first recipient.

In one aspect, the method may further comprise: (F) providing at least one reward to the first user based on the information received in (D).

In another aspect, the method may further comprise: (D)(1) receiving information related to a second user's interaction with the provided media in (C); and

(E)(1) allocating, based on the information received in (D)(1), at least a portion of the at least one unallocated donation to the first recipient.

In another aspect, the method may further comprise: (F)(1) providing at least one reward to the second user based on the information received in (D)(1).

In another aspect, the media provided in (C) above may be a first video.

In another aspect, the information received in (D) above may relate to the amount of the first video the first user views.

In another aspect, the method may further comprise: (G) providing a hyperlink to the media; (H) receiving information related to the first user's sharing of the hyperlink; and (I) allocating, based on the information received in (H), at least a portion of the at least one unallocated donation to the first recipient.

In another aspect, the method may further comprise: (J) providing at least one reward to the first user based on the information received in (H).

In another aspect, the method may further comprise: receiving information related to a third user's interaction with the provided media via the shared hyperlink in (H); and (L) allocating, based on the information received in (K), at least a portion of the at least one unallocated donation to the first recipient.

In another aspect, the method may further comprise: (J) providing at least one reward to the first user based on the information received in (K).

In another aspect, the method may further comprise: (E)(1) displaying the at least a portion of the at least one unallocated donation.

In another aspect, the media provided in (C) is a first augmented reality object.

In another aspect, the information received in (D) above relates to the first user's viewing of the first augmented reality object.

In another aspect, the media provided in (C) above is a first virtual reality environment.

In another aspect, the information received in (D) above relates to the first user's experiencing of the first virtual reality environment.

In one embodiment a non-transitory computer readable medium may have computer readable instructions embedded therein, the computer readable instructions being configured to implement a method when executed, the method comprising: (A) receiving information related to at least one unallocated donation; (B) receiving information related to a first recipient; (C) providing media over a network; (D) receiving information related to a first user's interaction with the provided media in (C); and (E) allocating, based on the information received in (D), at least a portion of the at least one unallocated donation to the first recipient.

In one aspect, the method may further comprise: (F) providing at least one reward to the first user based on the information received in (D).

In another aspect, the method may further comprise: (G) providing a hyperlink to the media; (H) receiving information related to the first user's sharing of the hyperlink; (I) allocating, based on the information received in (H), at least a portion of the at least one unallocated donation to the first recipient.

In another aspect, the method may further comprise: (J) providing at least one reward to the first user based on the information received in (H).

In another aspect, the method may further comprise: (K) receiving information related to a second user's interaction with the provided media via the shared hyperlink in (H); (L) allocating, based on the information received in (K), at least a portion of the at least one unallocated donation to the first recipient.

A person of ordinary skill in the art will understand, that any method described above or below and/or claimed and described as a sequence of steps is not restrictive in the sense of the order of steps.

The above features along with additional details of the invention, are described further in the examples herein, which are intended to further illustrate the invention but are not intended to limit its scope in any way.

### BRIEF DESCRIPTION OF THE DRAWINGS

Various objects, features and attendant advantages of the present invention will become fully appreciated as the same becomes better understood when considered in conjunction with the accompanying drawings, in which like reference characters designate the same or similar parts throughout the several views, and wherein:

FIG. 1 shows aspects of a media system according to exemplary embodiments hereof;

FIG. 2 shows aspects of acts performed by a media system according to exemplary embodiments hereof;

FIG. 3 shows aspects of a local application according to exemplary embodiments hereof;

FIGS. 4 and 5 show aspects of a media system according to exemplary embodiments hereof; and

FIG. 6 shows aspects of a computing system according to exemplary embodiments hereof.

### DETAILED DESCRIPTION OF THE PREFERRED EMBODIMENTS

The current invention relates to a system and method to enable the donation of money and/or resources from sponsors to social causes by tracking and rewarding interactions between participants and content provided by entities. The content providing entities may be producers of live events, movie studios, record labels, ad agencies, ad networks, musical artists, celebrities, athletes, sports teams, political groups, entertainment websites, news websites, cause based organizations and other types of individuals, groups or entities. As such, the current invention may increase and generally improve participant interaction and viewership for the entities. The system may be referred to as a Sponsored Ladder of Engagement (SLE) or a Donor Sponsored Content Engagement Network (DSCEN) but this in no way limits the scope of the invention and other terms may also be used.

In general, an entity that may wish to improve their interactions with their customers, communities or followers, while at the same time raise capital/resources for a particular cause(s) (e.g., a social cause, environmental cause, humanitarian cause, animal cause, educational cause, etc.) may register with the system. The entities may include nonprofit organizations, for-profit organizations, businesses, media companies, Fortune 500 companies, consumer brands, and any other type of entity, organization, group or individual and any combination thereof. The system may then provide and enable specialized applications to be deployed by the entity that may include media content (also referred to as “media”)—videos, articles, games, augmented reality objects, virtual reality environments, etc.—that may be consumed, shared and otherwise interacted with by participants (also referred as users, viewers, players and other terms). The media content may pertain to the cause to be supported and may tend to educate or otherwise inform the participants as to the benefits and contributions that the cause may provide, although this may not be required and the content may pertain to other subjects. The specialized applications may include mobile apps, interactive websites, desktop applications, social network pages or widgets, games, virtual reality applications, augmented reality applications or any other type or combination of types of applications. Note that the word “applications” may be used in this specification to represent any of these or other types of applications and in no way limits the scope of the invention to just those applications listed.

In addition, sponsors may be secured and may pledge to donate money and/or resources to the causes through the system every time an interaction between a participant and the application occurs. The sponsors may be secured by the entity, by the system or by any other person or entity. In some cases, the sponsors and the entities may be the same. In one example, a sponsor may pledge to donate $0.05 for every ten seconds of a particular video that may be viewed on a particular mobile application or website. Sponsors may be motivated to pledge donations through system 10 rather than simply donate directly to the cause because they may understand that they may receive significantly more publicity and measurable awareness because of the interaction of the participants. In addition, each participant may be better educated on the entity's content and regarding each cause and may spread the word across social networks and/or to their friends.

The system of the current invention may then integrate the entity's content, sponsors and the pledges within the applications, track and store metrics for each and every interaction performed by the participants Un, and organize, facilitate and generally manage all steps necessary to manage, calculate, allocate and collect the donations from the sponsors and deliver them to the appropriate entities. In this way, system 10 may provide an innovative turn-key solution for improving content engagement and fundraising programs with sponsors. The sponsors may include individuals, organizations, business entities, foundations, government agencies or other types of sponsors and any combination thereof. Donors may also include multiple donors that may partner or otherwise jointly participate with the campaigns. This will be described in further detail in later sections.

The system and method of the current invention will now be described in further detail with reference to the figures. The following detailed description is not intended to limit the current invention. Alternate embodiments and variations of the subject matter described herein will be apparent to those with ordinary skill in the art. Where the same or similar components appear in more than one figure, they are identified by the same or similar reference numerals.

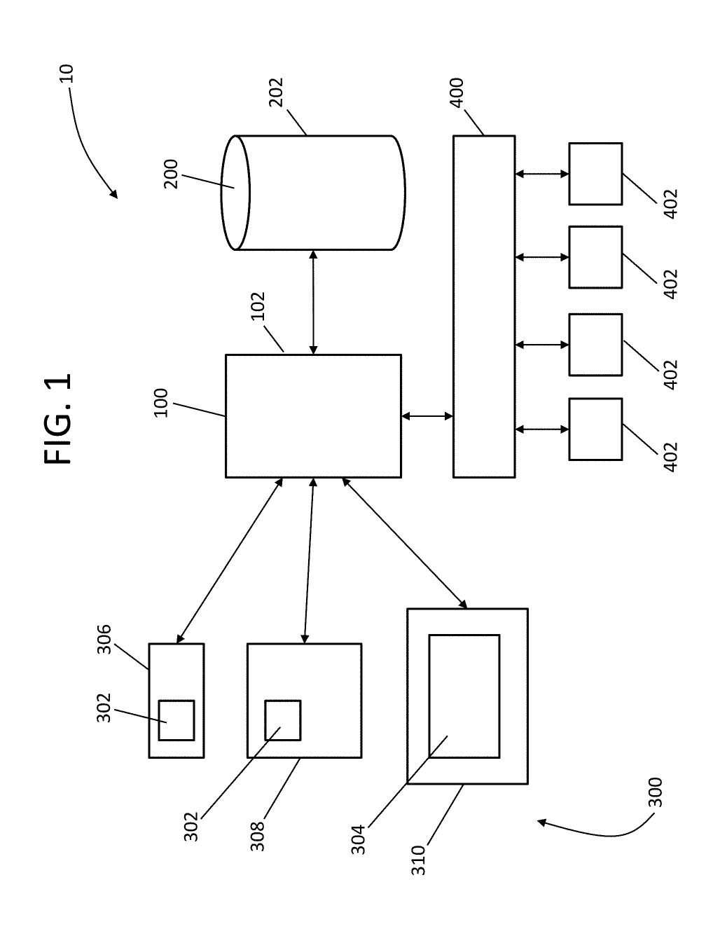

As depicted in FIG. 1, system 10 may include cloud platform 100, backend systems 200, local applications 300 and platform admin 400. Cloud platform 100 may comprise one or more servers 102 that may include Internet servers, LAN servers, or other types or combinations of types of generally networked servers. Accordingly, cloud platform 100 may include Central Processing Units (CPUs), microprocessors, memory, storage, software and other components and systems that may be required to run, manage, deploy and otherwise operate and control the programs and applications that may run within system 10.

Backend systems 200 may include database systems 202 and database management software such Sequel Server or other types of databases, database systems or database management software. These database systems 202 may store and generally manage client/entity data, content (media such as the videos in the example above), registered user data (i.e. participant data), data regarding sponsors, donations/pledges data, engagement tracking data, and other types of data. Platform 100 and backend systems 200 may also include any other types of software, software packages, software platforms or other types of software and systems that may enable system 10 to develop, host, manage, analyze and maintain mobile applications, websites, social widgets, desktop applications, network applications, and other types of applications that may perform the functions of system 10.

Local applications 300 may include mobile applications 302 (“apps”), websites 304 and other types of applications that may be deployed and operated through system 10. Mobile apps 302 may be available to be downloaded and installed onto each participant's mobile device (such as mobile phones 306, tablet computers 308 or other types of devices) that may run on iOS, Android or other types of operating systems. Websites 304 may be accessed via Internet browsers or other types of software that may reside on personal computers 310, mobile phones 306, tablet computers 308 or other types of devices. Note that while this specification may concentrate on local applications 300 that may include mobile apps 302 and websites 304, it is clear that local applications 300 may include other types of applications such as desktop applications, social network pages and widgets, games, virtual reality applications, augmented reality applications, or other types of applications, and that the current invention is not limited by the types of local applications 300 that it may utilize. In addition, it should be noted that system 10 may operate a variety of local applications 300 simultaneously. In the case of virtual reality applications, the participants Un may also utilize virtual reality headsets, apps, other devices or any combination thereof. In the case of augmented reality applications, the participants Un may also utilize augmented reality glasses, apps, other devices or any combination thereof.

In practice, an organization may register with system 10 and the organization's registration information may be stored within database system 202. This information may include but is not limited to the organization's name, contact information, description, business entity type, bank account information, and other types of information. The organization may also provide information regarding the causes they wish to support.

Once registered, system 10 may also provide each registered organization with admin 400 that may be used to generally administrate their account within system 10. Admin 400 may include interfaces 402 may be in the form of GUIs, websites, mobile applications, desktop applications or other type of interfaces. For example, admin 400 may include an interface 402 that may reside on a particular website URL that may be integrated with platform 100 and backend system 200. The interface 402 may first present a log-in page that may be used to log into system 10. Each organization may be given a username and password that they may enter to gain access to their particular admin interface 402. Once logged in, admin 400 may include tools required to manage their accounts with system 10.

For example, admin 400 may allow each organization to upload new media content that they wish to employ for participants Un to interact with. The content (also referred to as media) may include websites, images, banner ads, online surveys, mailing list sign-ups, blogs, videos, audio recordings, social postings, live video, virtual reality environments, augmented reality environments and other types of content. Note that the content may be new content specifically developed for participation with system 10, or may be other content of relevance that may now be monetized through system 10. Note also that the content may be developed by the organization or by other entities, and may specifically pertain to the cause being supported (although this may not be required). The content may be stored in database system 202.

Admin 400 may also allow registered entities to set and manage program parameters such as how each donation may be allocated (also referred to as “unlocked”), add new sponsors and programs, change settings of existing programs, and other useful administrative actions and protocols. Admin 400 may also allow each organization to track their programs in real time to see the capital/resources raised, to determine which programs are successful and which are less so, and to use this information to optimize its overall initiatives.

Specialized local applications 300 such as mobile apps 302 or websites 304 may then be designed, developed and deployed that may interface with platform 100, backend system 200 and admin system 400. In one example, mobile app 302 may be developed and branded for a particular organization and made available to be downloaded from the Internet (e.g. from Apple's App Store) or acquired from another source. Mobile app 302 may then be installed onto mobile devices such as mobile phones 306, tablet computers 308 or other type of devices. Mobile app 302 may be integrated with system 10 such that it may interface with platform 100 and backend system 200 over the Internet or other type of network.

In another example, website 304 may developed and branded for a particular organization and may be hosted and generally made available over the Internet to be accessed by a browser or other type of software on computers 310, mobile phones 306, tablet computers 308 or other types of devices. Website 304 may be integrated with system 10 such that it may interface with platform 100 and backend system 200 over the Internet or other type of network.

Once app 302 may be installed or website 304 accessed, each participant may be required to register with the system 10 so that their usage and general interaction with the content on mobile app 302 and/or website 304 may be tracked and monitored. However, it should be noted that this registration may be optional and that the participant may interact with the mobiles apps 302 or websites 304 without registering. The registration process may occur via app 302, website 304 or through a different type of dialog or interface and may require the user Un to input their name, email address and other information, but this may not be required. The participant registration information may then be stored into database system 202. Note that the registration data may be used to keep in contact with the participants Un and to provide them with updates regarding the various programs, to thank them for their participation and for other reasons. Note also that this may be regulated by an opt-in policy that may be agreed upon by each participant.

Platform 100 and backend system 200 may provide the organization's content to the participants Un via mobile app 302 and/or website 304, and the participants Un may interact with the content to “unlock” the pledged donations. Using the example above, platform 100 and backend system 200 may provide one or more videos to app 302 and/or website 304 to be offered to the participants Un to view. Platform 100 may receive a request from app 302 and/or website 304 for the content, and backend systems 200 may query databases 202 to retrieve the requested content. Platform 100 may then provide the content to the appropriate app 302 (at a particular IP address for instance) and track the interaction that may take place by the particular participant on the particular app 302 or website 304. Platform 100 may then continue to monitor the participant's interactions with the app 302 and/or website 304 and record the seconds/minutes of video they may watch. As platform 100 tracks the interactions, it may calculate the respective amount of donations that may be unlocked thereby.

It should be noted that the donations may not necessary be limited to cash currency, but may also include other types of metrics, services, goals, milestones, or other types of “currency”. For example, a particular program that may have a goal of protecting rain forests from deforestation in a particular part of the world may choose to have the donations displayed and tracked in the form of acres of rain forest that may be preserved. For instance, one acre of rain forest may be preserved for every ten minutes of video watched by the participants Un. In another example, the program may show and track the donation metric as meals served to homeless children in a shelter. Other types of metrics may also be displayed, tracked and utilized.

Platform 100 may utilize backend systems 200 to query the databases 202 to retrieve information regarding the organization's program such as the amount of pledged donations to be unlocked for each interaction (e.g. for every 6 seconds of video viewed in this example or for answering a survey, clicking a banner ad or sharing their email address). The tracking and unlocked donation information may be stored in database system 202 and may be tied to each particular participant within the database 202. In this way it can be seen that platform 100 and backend systems 200 may be continually interfacing with apps 302 and websites 304, receiving requests for content, querying databases 202 for the content, providing the content to the particular app 302 and/or website 304, tracking all interactions with the delivered content, storing the tracking data in databases 202, using the tracking data and the organization's program parameters to calculate the donations that may be unlocked by the tracked interactions, and providing this data back to the apps 302 and/or websites 304 to be displayed in real time. It can be seen that system 10 may thereby improve the efficiency and the performance of the fundraising platform by continually interfacing and updating the apps 302 and/or websites 304 in real time. It can also be seen that system 10 may provide incentives of unlocking donations to the participants Un to optimize their engagement.

Note that a wide multitude of content may be made available to app 302 and/or website 304 by platform 100 and backend system 200, and that a portion or all of the content may be available to the participant Un through the app 302 and/or website 304 at any given time. The participant Un may then enjoy the content and platform 100 may monitor and track each and every activity, including time spent, that the participant may engage in.

In order to better engage the participants Un to interact with the content on app 302 and/or website 304, pertinent information regarding the organization, the cause(s) being supported by the organization and their various program(s) may also be made available through app 302 and/or website 304. This information may include but is not limited to a description of the organization and the cause(s), its contact information, people and/or celebrities that may be associated with the organization and/or cause(s), the benefits the organization and/or cause(s) may provide, areas of the world that may benefit from the programs, and other information. This information may all be stored in database system 202 and may be provided to app 302 and/or website 304 as needed and whenever appropriate.

Participants Un may also earn points for each interaction they perform and for each donation they unlock. For example, the users Un may receive a point for every ten seconds of video they view. The system 10 may keep track of each participant's points in addition to the amount of donations they may unlock. These points may be used to rank the participants Un according to their amount of interaction they have performed, the amount of donations they have unlocked as well as other metrics. The earned points may also be redeemed for discounts off the sponsoring brand's products or services, prizes, cash payouts, services or for other rewards. The participants Un may also donate all or a portion of their earned points to the non-profit, charity, the cause or to other entities. In addition, one or more grand prizes may be issued to the participants Un that may earn the most amount of points. It may be preferable that the participants Un register with the system 10 in order to receive the reward points, but this may not be required.

The reward points may be provided by the organizing entity(s) of the campaign(s), by the donors, by the providers of the system 10, or by any other source and any combination thereof. For example, an organizing entity may offer reward points for engagement with their specific campaigns (campaign specific reward points), the donors may offer reward points for engagement with the campaigns they may be providing donations to (donor specific reward points), and the managers of the system 10 may offer reward points (e.g., universal reward points) for all engagements across the entire platform. The different reward points may be combined in any way and used to receive prizes, awards, services, discounts, etc. The reward points may also be donated to the fund-raising entity, to any other entity or any combination thereof.

In addition, app 302 and/or website 304 may display information regarding the pledged donations associated with each piece of content in real time as described above. Some content may show the pledges that may be unlocked in the form of currency, while others may show the donations in the form of metrics that may be relevant to the cause being supported (e.g. acres of rain forest to be preserved). In this way, each participant may immediately gage which activities they may wish to engage with and how many donations they may unlock and make available by doing so.

The app 302 and/or website 304 may also show information regarding the sponsors, who they are (for instance, they may be celebrities, brands or other influential people or entities), their mission statements, why they are donating, how much they plan to donate, how to get in contact with them, and other information. However, it should be noted that parameters of the program may be set to not show this information as necessary or desired by the organization or sponsors.

It should be noted that the types of interactions that may unlock (allocate) donations may include, but are not limited to: watching videos, clicking banner ads, answering surveys, interacting with augmented reality environments and/or objects, interacting with virtual reality environment and/or objects, signing up to mailing lists, reading blogs, reading articles, viewing images, playing games, listening to audio, sharing the content with friends via social networks, email or by other means, commenting on the content, referring the app 302 and/or website 304 to a friend to be downloaded and installed on their device or visited, volunteering to help and/or attend an event, donating to the cause themselves, and other types of activities.

For instance, the app 302 may list an audio recording and show that for each minute of the audio that the participant listens to, $0.10 may be unlocked and donated by the sponsor. The app 302 may also show that if the participant shares the audio with their friends through a social network (such as Facebook), that an additional $0.20 will be unlocked and donated for each friend shared with. In this example, it can be seen that sharing the video over social networks may unlock higher donation amounts than viewing the video, and in this way participants Un may be motivated to perform the higher value actions. These examples are described as demonstrations and are only meant to represent examples of what interactions may be performed to unlock donations for the cause and in no way limit the scope of the system 10. As described above, many different types of interactions may be utilized.

As each participant interacts with app 302 and/or website 304 in these ways, more and more donations may be unlocked by the participant. As each interaction takes place, platform 100 and backend system 200 may monitor, track and store information regarding each interaction, may analyze the data and may provide the data back to app 302 and/or website 304. In this way, app 302 and/or website 304 may show in real time how much capital/resources that each participant has unlocked for the cause, and may rank the participants Un according to these amounts. It should be noted that platform 100 and backend 200 may update in real time all instances of local applications 300 (at each and every IP address for example). In this way, each instance of each app 302 and each website 304 that different participants Un may be engaging with may all simultaneously display up-to-date information regarding each and every participant's interactions and unlocked donations. The information may be presented individually for each participant to see his/her unlocked donations, in aggregate including all of the unlocked donations by all participants Un, and any combination thereof.

The app 302 and/or website 304 may also show a goal that the organization may wish to achieve for each program, as well as the amount towards the goal that has been accomplish thus far. In this way, it can be seen that the acknowledgement given to the participants Un for their time and effort by the displaying of this information may inspire the participants Un to interact even further with the app 302 and/or website 304 in order to increase the amount raised and reach the goal(s).

In one example, a video may be uploaded to system 10 at which time system 10 may detect or otherwise determine that the length of the video is one minute long. The organizing entity may then set that an amount of one cent may be donated to the nonprofit for every six seconds of video viewed by each participant. Note that in this example a total of ten cents may be donated for each video watched to completion. Once this information is entered into system 10 using admin 400, system 10 may place these parameters into the local or front end applications 302, 304. The front end applications 302, 304 may display information regarding the donations as they occur in real time such that each user/viewer may be able to easily view the amount of donations they may be unlocking as they view the videos, and how much more is available to unlock if they continue to watch. The system 10 may also display the total number of participants Un viewing the video and a summation of all the donations unlocked by all of the participants Un in real time in aggregate such that all participants Un can see their overall accomplishments. This may be especially relevant during a broadcast of a live event such as a music concert or a sporting event when a large number of participants Un may be watching the event together in real time. Given this, it can be seen that this displayed information may encourage the users Un to continue watching the videos so that they may unlock further donations for the cause. Note that this information may be displayed in close proximity to the video player deployed on the app or website such that the viewers may easily see the information.

In one example of this, and entity such as a major international bank may sponsor the live streaming of a musical concert such as Adele to benefit a nonprofit organization such as Doctors Without Borders. As many as ten thousand or more viewers may simultaneously view the live stream broadcast and work together (while viewing their own individual unlocked donations and the aggregate unlocked donations of the entire group) to unlock tens of thousands of dollars of donations for the charity.

As the participants Un continue to engage with the videos, system 10 may keep detailed records of a wide variety of data regarding the viewership of the videos and the demographics of the participants Un. In this way, system 10 may provide for the cross correlation of the data for marketing analysis purposes. For example, system 10 may track which videos had the most participants Un that watched the videos to completion, and which videos had less. System 10 may also track the demographics of the participants Un (e.g., geographical location, age, gender, household income and other pertinent information) and provide this information to the organizing entity, the donors or to any other organization. Information regarding how much of each video (e.g., 25%, 50%, 75%, 100% or other tracked amounts) each participant engaged with may also be captured and provided. The system 10 may also track, record and provide information relating to the amount of donations allocated (unlocked) per engagement, the number of shared campaigns (e.g., via links 319), the bounce rate, unique users and other information.

Note that some of this information may be available through the tracking of IP addresses and such while other portions of the information may be provided by the participant during registration (optional). With this information, system 10 may run statistical analysis reports that may allow the managing entity to correlate the most engaged videos with the demographics of those participants Un that engaged the most. It can be seen that with this type of reporting, the programs may be optimized for maximum traction. For instance, it can be determined which videos may be more popular in different geographical locations or to which gender. Note that the above example is meant as a demonstration of the types of information that system 10 may collect and the types of analyses that it may perform, and it will be clear to those of ordinary skill in the art that system 10 may be able to track and collect a wide multitude of important data regarding the participants Un and the interactions they may take with the provided media. It is also understood that the scope of system 10 is in no way limited by the types of information it may collect.

In addition, in the example of a live event broadcast, the video may be archived and available for playback for users Un who may have missed it or for those who wish to view it again. In this case, the entity may decide to set the same or a different donation scale compared to the live event. If the entity sets a lower donation scale for the archived version (for example, one cent for every twelve seconds of video viewed compared to one cent for every six seconds of video viewed), it can be seen that the participants Un may be incentivized to watch the event live in order to unlock more donations at a faster rate.

Additional information may be shown on app 302 and/or website 304 pertaining to the amount of funds/resources donated by each sponsor as the participants Un engage with the content. In this way, each sponsor may also be acknowledged for their patronage for each cause, and may be inspired to pledge even further.

In addition, secondary calls to action may be displayed in close proximity to the videos or other content in order to drive further traction and engagement with the entities and the causes they may be promoting. For example, social network icons may be displayed that once clicked may allow for the easy sharing of the content across the social networks. In another example, the viewers may be able to purchase merchandise or tickets to future events from celebrities or music artists. The entities and/or sponsors may also include opportunities for additional money or resources to be provided to the causes through these secondary calls to action by donating a portion of the revenue generated by the merchandise or ticket sales to the causes.

It should be noted that each program that may run within system 10 may have a start date, a stop date, and duration, or may be open ended. In addition, system 10 may collect the unlocked donations from the sponsors for each particular program throughout the duration of the program, at the end of the program or at any other time.

Each sponsor may provide their bank account information to system 10 such that system 10 may withdraw the unlocked donations per their agreement with each sponsor. The sponsor may or may not be required to approve each withdrawal. In addition, each sponsor may provide system 10 with a retainer that may be held (e.g., in an escrow account) and used to draw down the unlocked donations in real time or in one or more lump sums during or after the campaign may end. Or, each sponsor may receive an invoice at a predetermined time for each program to be paid within agreed upon payment terms. In any event, each sponsor may provide a method for system 10 to receive the pledged donations that may have been unlocked.

Once the donations are received, secured and allocated by system 10, system 10 may provide them to the appropriate entity(s) (e.g., the recipient of the donations). This may occur via check, direct deposit or by other means. System 10 may provide the donations to the organizations, to the causes directly or to other appropriate entities or individuals. Alternatively, each sponsor may deliver the pledged donations directly to the nonprofit organization with or without the assistance of system 10.

It should also be noted that a fee for system 10 or the use of system 10 may also be charged to the managing entity, the nonprofit entity, the donors, or to any other appropriate entity. In this way, system 10 may generate revenue. The fee structure for the use of system 10 may be associated with each video deployed, each overall campaign for each nonprofit, over a specified amount of time, or any other or combination of any fee structure.

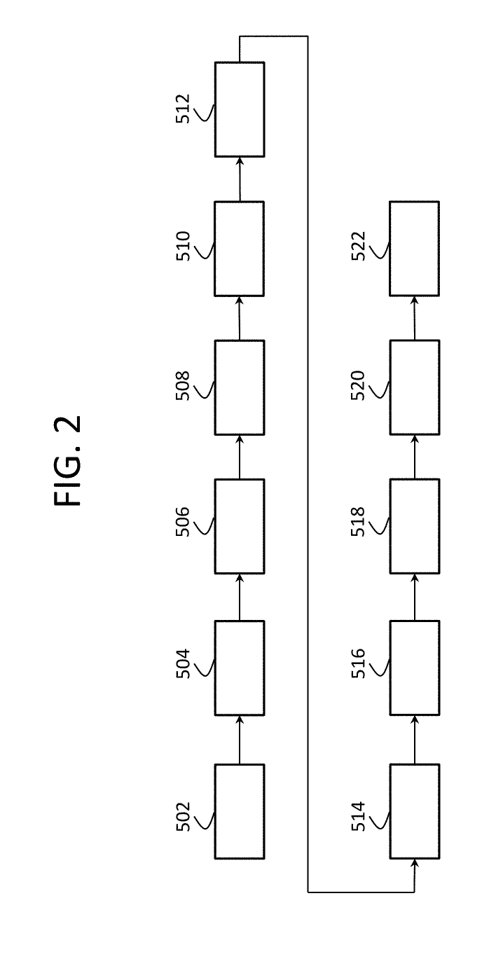

Turning now to FIG. 2, the process by which system 10 may generally operate given the above described scenarios is now described. Note that these steps are shown for demonstrative purposes and that other steps may be taken in addition to those described, some or all of the steps described may not be taken, or the steps may be taken in different orders, without limiting the scope of the system 10.

As depicted, an organization may register with system 10 at node 502.

Next, at 504, each organization may secure sponsors to participate in each program by pledging donations as described above.

At 506 the organization may utilize admin 400 to set the parameters of the program they wish to run. This may involve uploading content, setting pledge parameters, adding sponsors, and other activities.

Applications such as mobile apps 302, websites 304 and other applications may be developed and deployed (node 508).

At 510, participants Un may download apps 302 or access websites 304, and upon doing so, may register with the system 10. Note that registration may be optional.

Once the participants Un have registered (optional) and they gain access to the app 302 or website 304, system 10 may provide the content to the apps 302 and websites 304 (node 512).

Upon receiving the content, the participants Un at 514 may interact with it.

At 516, system 10 may track and monitor all interactions across all instances of app 302 and website 304 simultaneously in real time.

And at 518, system 10 may unlock pledged donations depending on the monitored interactions

At 520, system 10 may update in real time all instances of apps 302 and websites 304 regarding all unlocked donations.

And at 522, system 10 may then secure the donations from the sponsors and provide them to the appropriate entities.

The benefits of the current invention are multifold. First, the system 10 improves both the time users Un engage with content and the return on investment a sponsor receives from the donations they are making to causes by providing a turnkey self-contained system. Participants Un are educated and entertained with content while interacting with the system, and are inspired to continue watching in order to unlock the sponsors' donations. In addition, sponsors are motivated to pledge donations due to the traction and social awareness that the system 10 provides to causes they may be interested in supporting.

In addition, each participant who registers may be contacted again with updates and new information, establishing long term relationships for future programs.

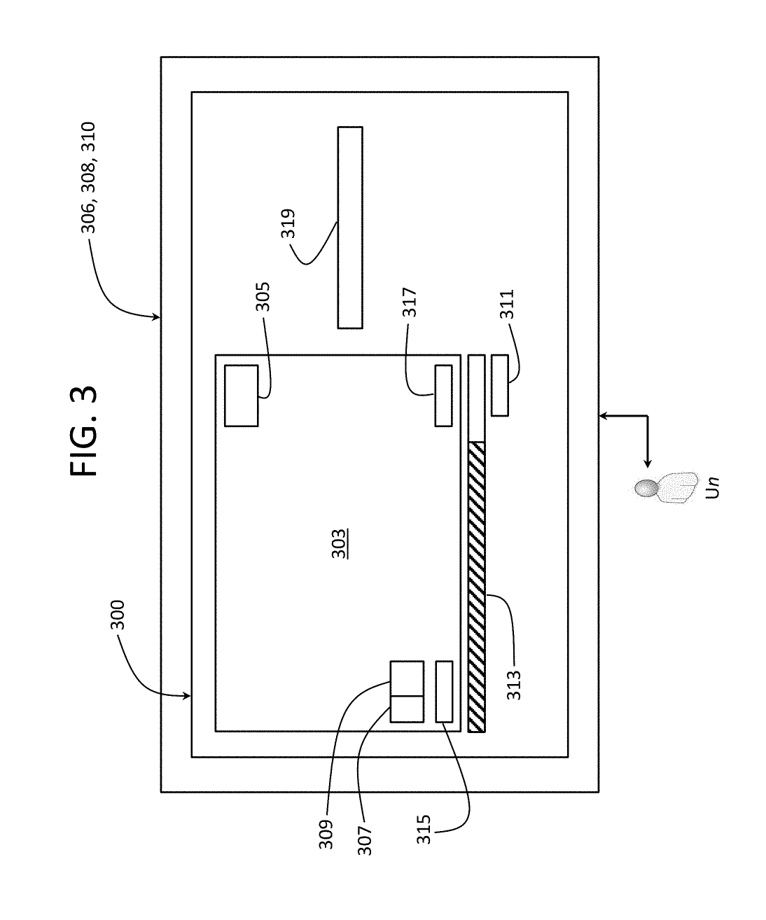

An exemplary implementation of system 10 is depicted in FIG. 3. As shown, a user Un may interact with a media player 303 (e.g., a video player or other type of media player) that may be embedded into a local application 300 (e.g., a mobile app 302 and/or a website 304) that may reside and/or run on a mobile phone 306, tablet computer 308, personal computer 310 or other type of device. The media player 303 may be integrated with the system 10 to play, deliver or otherwise provide content (media) to the participants Un, and the system 10 may track the content consumed, shared, etc. as described.

The local application 300 may include a real time donations counter 305 that may display or otherwise represent the amount or number of donations that may be unlocked in real time as the participant Un interacts with the media player 303 (e.g., watches a video). The counter 305 may display money donated, the number of trees saved/preserved, or any other type of representation of the donations unlocked. As the participant views the media, the counter 305 may preferably continually track and display the donations unlocked in real time or near real time so that the user Un may see the donations being unlocked as they view. In one preferred implementation, the counter 305 may be integrated with the media player 303 as shown but it is contemplated that the counter 305 may also be located in other locations.

The local application 300 may also include a user image 307 that may represent the user Un (e.g., a thumbnail image or avatar of the user Un) as well as a real time earned points counter 309 that may display or otherwise represent the amount or number of points in real time that the participant Un may earn as he/she interacts with the media player 303 (e.g., watches a video). As the participant views the media, the counter 309 may preferably continually track and display the points earned by the user Un in real time or near real time so that the user Un may see the points being earned as they view. In one preferred implementation, the counter 309 may be integrated with the media player 303 as shown but it is contemplated that the counter 309 may also be located in other locations. Note that it may be preferable for the user Un to register and log into the system 10 in order for this information to be displayed, but this may not be necessary and the system 10 may use cookies or other technology to identify the users Un.

The local application 300 may also include an indicator 311 of the campaign goal (e.g., how much money in donations unlocked, how may trees preserved, etc.) and a real time goal reached indicator 313 of the amount reached thus far (i.e., the percentage of the overall goal reached at that moment). As shown in FIG. 3, the indicator 313 may include a numerical number (e.g., the amount of money unlocked) and/or a bar graph that may extend from left to right that may visually display the percentage of the total goal reached.

The local application 300 may also include an indicator 315 of the amount of time left of the current campaign so that the users Un know how much time they may have left to unlock donations and earn points. In addition, the app 302 and/or the website 304 may also include the logo and/or name of the sponsor(s) 317 that may be the donor(s) for the campaign.

In this implementation, the view Un may watch the video playing on the media player 303 while viewing in real time the number of donations he/she may be unlocking, the number of points he/she may be earning, the total amount of donations unlocked and the percentage of the goal reached thus far.

The local application 300 may also provide a unique hyperlink 319 (e.g., a URL) to each participant Un that the participant Un may share with his/her network or community of contacts. It may be preferable that the user Un be registered with the system 10 in order to receive the unique link 319, but this may not be required. The user Un may share the unique link 319 via email, social networks, postings, text messages, tweets, other types of sharing methods and any combination thereof. When shared and subsequently clicked by new users Un, the unique link 319 may lead the new users Un to campaign media players 303 that may provide the same or similar media that the new participants Un may interact with to unlock donations, earn points, etc. as described. The system 10 may also track the interaction(s) the new participants Un may perform with the media (e.g., the system 10), and may credit the sharer of the link 319 with additional points, rewards, etc. In this way, the sharer of the link 319 may earn additional reward points for each interaction stemming from his/her sharing of his/her unique link 319.

The system 10 may track the overall number of points earned by each participant Un (whether from his/her own interacting with the media, from sharing the media, from their shared contacts interacting with the media, or by other means), and may award top performers with prizes. For example, a person who earns over 5000 points may be awarded a particular prize. In another example, the person who shares the campaign with the most additional contacts (e.g., shares their unique link 319), may earn another particular prize. In another example, the participant Un that earns the most points overall may win a grand prize. In this case, the system 10 may display a leader board that may display the point-earning leaders of each campaign, thus driving competition to earn more points by other participants Un. Note that the prizes may be provided by the donors, the recipient entities, the managing entity(s) of the system 10, or by other entities.

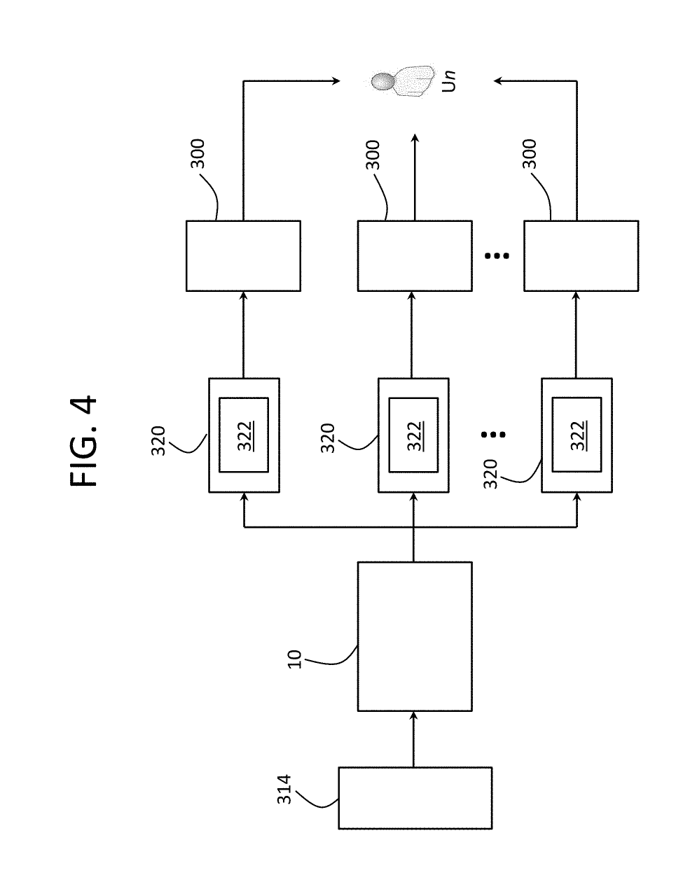

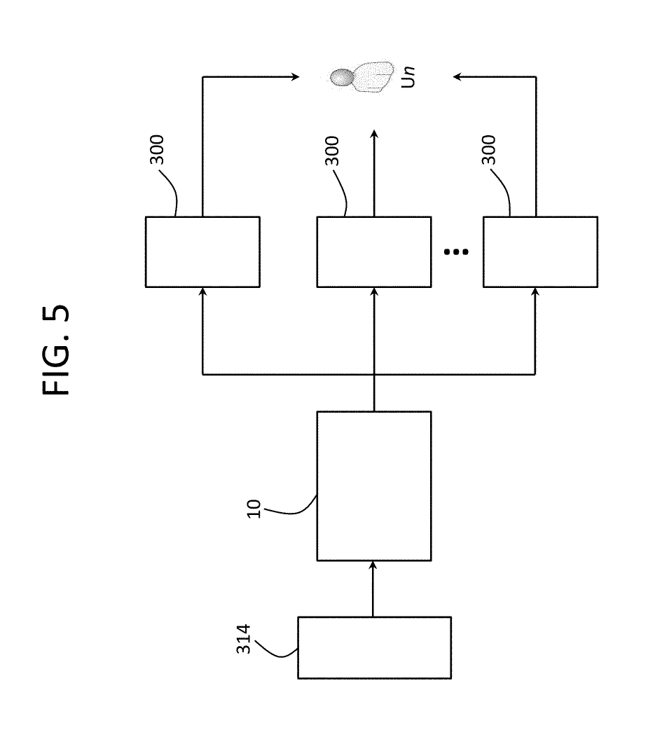

Turning now to FIG. 4 and FIG. 5, additional information regarding the implementation of system 10 will now be described in order to give further clarification and details of system 10. System 10 may be integrated into third party platforms 320 that may drive websites, mobile apps, desktop applications, networked applications, or other types of applications. The third parties may be publishers of websites and online content, social networks, ad networks, ad agencies, publishers and/or developers of mobile apps, or other type of entities. In addition, the third party entities may develop their own content to be deployed, may host content from other developers, brands, causes, sponsors or any other type of entity, or any combination thereof.

Accordingly, the third party platforms 320 may include backend systems and frontend systems or applications. The backend systems may include servers 322 that may be Internet servers or other types of networked servers or platforms capable of performing the operations necessary as described in this specification. The frontend systems or applications may be websites, mobile apps, desktop apps, video players, digital advertising networks, and other types of frontend systems and applications. It should be noted that these frontend applications may include and/or may be similar to the local applications 300 described in the sections above with reference to FIG. 1, such as mobile apps 302 that may run on mobile phones 306, tablet computers 308 or other types of devices, and websites 304 that may be accessed through Internet browsers that may reside on personal computers 310, mobile phones 306, tablet computers 308, game consoles or other types of devices. For this reason, frontend applications of FIG. 4 and FIG. 5 will also be denoted with reference numeral 300.

Note that while this specification may concentrate on frontend applications 300 that may include mobile apps 302 and websites 304, it is clear that frontend applications 300 may include other types of applications such as desktop applications, social network pages or widgets, television applications, automobile applications, multimedia device applications, virtual reality applications, augmented reality applications, location based applications or other types of applications, and that the current invention is not limited by the types of local applications 300 that it may utilize. In the case of virtual reality applications, the participants Un may also utilize virtual reality headsets, apps or other devices. In the case of augmented reality applications, the participants Un may also utilize augmented reality glasses, apps or other devices. In addition, it should be noted that system 10 may operate a variety of local applications 300 of any kind simultaneously.

In general, the third party backend platforms 320 may include software development kits (SDKs) that may include a set of software development tools that may allow for the creation of applications for particular software packages, software frameworks, hardware platforms, computer systems, video game consoles, operating systems or other types of platforms or applications. The SDKs may be used by developers to create applications that may run seamlessly on the third party backend platforms 320 so that they may be deployed on or as part of their frontend applications 300 as well (as seen in FIG. 4). In other cases, the SDKs may allow for partnering platforms to interface and work directly with third party local applications 300 without necessarily having to interface with the third party's backend servers 322 (as seen in FIG. 5).

In addition, the third party backend platforms 320 may include application program interfaces (APIs) that may include a set of routines, protocols, tools and other elements for defining and specifying how software components and systems may interact. These APIs may be used to seamlessly connect one platform (such as system 10) to another platform (such as the third party backend platforms 320) such that the connected platforms may share data and other functionalities.

Given this, system 10 may implement the SDKs and APIs of the third party platforms to integrate its backend capabilities with the third party platforms 320 or applications 300. In this way, system 10 may deploy applications that may run on the third party's apps 302, websites 304 or applications that may run on the third party platform 320. Note that in this scenario, system 10 may host and provide the content such as the videos or other content that may be delivered to the participants Un (viewers of the video in this example) via the applications. In addition, system 10 may perform all of the other functionalities as described in the sections above such as tracking the time that each participant Un may view each video, if the participant Un shares the video with their friends, and all of the other types of actions that system 10 may track as described above. By utilizing the SDKs and APIs of the third party platforms 320, system 10 may also update the third party platform 320 and/or applications 300 in real time to display the amount of donations unlocked, and may be used to update the applications via the administration dashboards 402. It should be noted that all of the functionality described in the above sections may also be performed by system 10 in this scenario. Note that the content deployed may be provided by the third parties or from other developers, brands, causes, sponsors or any other type of entity, or any combination thereof.

In one example, the third party platform 320 may be a social network that may provide an SDK and/or a set of APIs for developers to use to integrate their platforms into the social network pages or widgets. The SDK and the APIs may be used to integrate system 10 into the social network's platform so that system 10 may power an application or page on the social network for their members may view, use and generally interact with. The result may be a social network application that may deliver videos to its members to watch and unlock donations as described above. All of the other functionalities of system 10 may also be available.

In another example, the third party platform 320 may include a virtual reality (VR) platform that may host or otherwise provide videos, three-dimensional objects, worlds, avatars, games or other types of virtual reality (VR) elements generally within a VR environment for participants Un to view and otherwise interact with (e.g., shooting a laser at a target within the VR environment). The participants Un may view and/or interact with the VR elements by utilizing virtual reality goggles, game consoles, apps or other types of virtual reality devices that may or may not be connected to the Internet or a different network, through a website 304, an app 302 or through any other type of VR enabled system. The VR platform may provide an SDK and/or a set of APIs that may allow system 10 to be integrated with the VR platform. As with the other types of content (such as video) described in sections above, system 10 may be configured to unlock donations for interactions that the participants Un may have with predefined VR elements. System 10 and the VR platform may work in conjunction to track the interactions of each participant with the VR elements provided by the VR platform in order to unlock the earned donations and provide rewards points to the user Un as described above. All of the other functionalities of system 10 may also be available. Note that in this example the VR content may be provided by one or more sponsors or any other entities that may be partnering in the fund-raising campaigns.

In another example, the third party platform 320 may include an augmented reality platform that may be integrated with system 10 in order to track and unlock donations according to interactions participants Un may have with real world objects viewed through the augmented reality system. The participants Un may view and/or interact with the real world objects by utilizing augmented reality glasses, goggles, mobile apps, or other types of augmented reality enabled devices or systems that may or may not be connected to the Internet or a different network, through a website 304, an app 302 or through any other type of augmented reality enabled system. The augmented reality platform may provide an SDK and/or a set of APIs that may allow system 10 to be integrated with the augmented reality platform. The augmented reality system may be configured to recognize particular real world objects (e.g., via a camera configured with the AR system) and in conjunction with system 10 may track and give credit (i.e. allow for donations to be unlocked and for reward points to be awarded) for viewing or otherwise interacting with these objects. For example, the augmented reality system may be configured to unlock donations for participants Un who view a particular product by a particular brand on a shelf at a particular store for a specified amount of time. In this example, the AR application (e.g., including a camera configured with a user device 306, 308 and the system 10) may recognize the particular product that the user Un may be interacting with. The augmented reality system configured with system 10 may also recognize the location of the participants Un and be programmed to unlock donations and issue reward points for participants Un who go to and/or stay in a particular location for a specified amount of time. For example, donations may be unlocked by participants Un who spend a predetermined amount of time within a sponsoring store. This may be accomplished through integration with GPS systems, by the system 10 recognizing the surroundings and/or the products, or by other location determining means. System 10 and the augmented reality platform may work in conjunction to track the interactions of each participant with the predetermined real world objects and/or track the time spent in a particular location in order to unlock (allocate) the earned donations and provide reward points to the user Un as described above. Other activities associated with augmented reality systems such as picking up an object or other activities may also be programed to unlock donations. All of the other functionalities of system 10 may also be available. Note that in this example the AR content may be provided by one or more sponsors or any other entities that may be partnering in the fund-raising campaigns.

In another example, the third party platform 320 may include a local search and discovery service (such as Foursquare), a location service, and/or location application that may track the precise physical location of the participants Un who enable the application on their mobile phone 306, tablet computer 308 or other type of device. The platform may or may not use GPS or some other location system. In this example, the location platform or application may provide an SDK and/or a set of APIs that may allow system 10 to be integrated with the location platform or application. In this way, the platform 320 may work in conjunction with system 10 to track the location of the participants Un and to unlock donations for participants Un who go to and/or stay in a particular location for a specified amount of time. For example, donations may be unlocked by participants Un who spend a predetermined amount of time within a sponsoring restaurant or store. Other activities associated with search and discovery services, location services or location applications such as ranking a restaurant that the participant may be eating at, posting a comment for a movie that the participant may be viewing at a particular movie theater or other activities may also be programed to unlock donations. All of the other functionalities of system 10 may also be available.

It should be noted that these examples are meant for demonstration purposes and that a person with ordinary skill in the art will recognize that there are many other ways of how system 10 may be integrated into third party platforms to perform the functionalities as described above, and that the scope of the system 10 is not limited in any way by the types of third party systems and platforms with which the system 10 may be integrated with, in the types of interactions between the participants Un and the third party systems and platforms (and the system 10), or in the method of the integration.

System 10 may include its own set of SDKs and APIs that may allow third party platforms 320 to be integrated with system 10. This may be preferable if one or more third party platforms 320, donors, causes, or other type of entities wish to deploy their own videos or other content to be used as a part of system 10. In this case, the third party platforms 320, donors, causes, or other type of entities may be integrated with system 10 such that they may provide the videos or other content to system 10 for system 10 to deploy to participants Un in conjunction with the third party platforms 320 through mobile apps 302, website 304 or other channels.

System 10 may also include its own virtual reality platforms and/or augmented reality platforms such that virtual reality elements and/or augmented reality elements may also be deployed through system 10 to be interacted with as well. In this way, system 10 may track the time each participant may interact with the videos, VR elements, augmented reality elements or other types of media, may unlock the appropriate donations and may generally perform all of the other functionalities as described above, but the videos, virtual reality elements and/or augmented reality elements or other content may be provided by the third party platform 320. The third party platform 320 may also have access to the admin 400 to manage the programs.

System 10 may also include its own local search and discovery service, location service and/or location applications that may track the precise location of the participants Un who enable the app on their mobile phone 306, tablet computer 308 or other type of device. System 10 may include its own set of SDKs and APIs that may allow third party platforms 320 to be integrated with system 10 in order to unlock donations to participants Un who go to and/or stay in a particular location for a specified amount of time. For example, donations may be unlocked by participants Un who spend a predetermined amount of time within a sponsoring shopping mall. Other activities associated with search and discovery services, location services or location applications such as posting a comment about a particular art show at a particular museum that the participant may be visiting, viewing a particular movie at a particular movie theater or other activities may also be programed to unlock donations. All of the other functionalities of system 10 may also be available.

Note also that system 10 and the third party platforms 320 may run together in any combination of these scenarios. That is, some of the content may be provided by system 10 and some of the content may be provided to system 10 by the third party platforms 320 or any combination thereof. In addition, the content deployed may be provided by the third parties or from other developers, brands, causes, sponsors or any other type of entity, or any combination thereof.

System 10 may also have the ability to run one or more particular campaign across multiple third party platforms 320 simultaneously while unlocking donations from one or more donors. That is, a particular cause may have several different third party platforms 320 unlocking donations to the cause across different platforms, applications 300, apps 302 or websites 304. For example, different, similar or identical videos (or any combination thereof) may be provided by different third party platforms 320 through different apps 302 or on different websites 304 to different participants Un to view such that all of the interactions may be applied to unlock donations for the same cause. System 10 may track all of the interactions across all of the third party platforms 320, applications 300, apps 302, websites 304 or other applications and apply the unlocked donations to the cause. System 10 may also keep track of which donations were unlocked on which platforms such that it may provide statistics on all the platforms 320 and/or applications 300 and the donations unlocked by each. It can also be seen that this may include multiple causes as well, and that system 10 may track all of the interactions across all the platforms 320, applications 300, apps 302, websites 304 or other applications and apply the unlocked donations to each particular cause that may be assigned to each particular interaction. One or more donors may participate at any time and multiple donors may include partnering companies or entities. Note also that the content may be provided by system 10, may be provided to system 10 by the third party platforms 320, or by any combination thereof.

In one example of this type, a prominent bank may be the main donor and may provide the content on its own platform (e.g. videos on its company website) such that system 10 may track and display the unlocked donations. Another company may then wish to also participate in the same campaign and may embed a widget into a company-wide email that may allow its employees to view the same or different content on a desktop application. System 10 may then track interactions on both platforms and/or channels, i.e. the bank' website platform as well as the second company's desktop application. System 10 may track and store the unlocked donations across both platforms and may display in real time the totals on either or both platforms. In another example, a video may be published on three different publisher sites and system 10 may track the interactions with the video across each site, aggregate the data, and unlock the resulting combined donations.

In addition, one or more donors 314 may participate in any of these scenarios in a similar fashion as described above. That is, multiple donors 314 may pledge to donate money or resources to one or more programs that each may reside on one or more different platforms and/or applications as described above, whether the content is provided by system 10 or by the third party platforms 320, or by other entities or any combination thereof.

It should also be noted that system 10 or the use of system 10 may be offered to potential clients for a cost or at no cost. In the case where system 10 or the use of system 10 is offered at a cost, the clients paying the cost may be the entities running the third party platforms 320, the entities delivering the frontend applications 300, the donors 314, the cause related entities receiving the donations, the content providers, third party ad networks or any other type of entity. In addition, it should be noted that the donors 314 may include the entities running the third party platforms 320, or other types of donors as described above.

It should be noted that in all of the examples, scenarios and embodiments of system 10 described in this section, that all of the capabilities and functionalities of system 10 as described in earlier sections are also included and applicable.

The following list shows example technical platforms, software packages, applications, protocols, systems, languages and other types of technical specifications that may be used in conjunction with system 10. However, it should be understood that this list is not exhaustive and is meant only for demonstrative purposes and that other technical platforms, software packages, applications, protocols, systems, languages and other types of technical specifications may be used in conjunction with system 10 for any purpose or function as required.

Database: Relational Aurora MySQL on Amazon RDS (master and slave combination), MySQL, MariaDB, PostrgeSQL, MongoDB

CMS: Built using the Drupal Open Source PHP framework and hosted on Elastic Beanstalk for scalability on NGINX server, Custom, Joomla, Wordpress

API: Javascript on a Node.js server for high concurrency and speed and hosted on Elastic Beanstalk for scalability (multiple web heads), PHP, Python, Go

Analytics: Pipeline from Amazon Kinesis streaming incoming data, processed with a node.js Lambda function to DynamoDB (NoSQL) which is secondarily processed with node.js Lambda function to store final data in MongoDB (NoSQL), PHP, Python, Go

Static files: Hosted on Amazon S3 and served via Amazon Cloudfront, Linux Hosted Servers, Rackspace

Videos: Ingested in to Kaltura for transcoding and pushed out to Akamai HD CDN for Edge Network distribution, Amazon Elastic Transcoder, Encoding.com, Brightcove, AWS Cloudfront, Verizon Edge

iOS/tvOS: Objective-C, Xcode, Swift

—Android/Android TV: Java, Kotlin

HTML5/Tizen: Javascript

Roku: Brightscript

Web: Javascript

### Computing

The functionalities, applications, services, mechanisms, operations, and acts shown and described above are implemented, at least in part, by software running on one or more computers (e.g., the cloud platform 100, backend systems 200, and user devices 306, 308, 310).

Programs that implement such methods (as well as other types of data) may be stored and transmitted using a variety of media (e.g., computer readable media) in a number of manners. Hard-wired circuitry or custom hardware may be used in place of, or in combination with, some or all of the software instructions that can implement the processes of various embodiments. Thus, various combinations of hardware and software may be used instead of software only.

One of ordinary skill in the art will readily appreciate and understand, upon reading this description, that the various processes described herein may be implemented by, e.g., appropriately programmed computers, special purpose computers and computing devices. One or more such computers or computing devices may be referred to as a computer system.

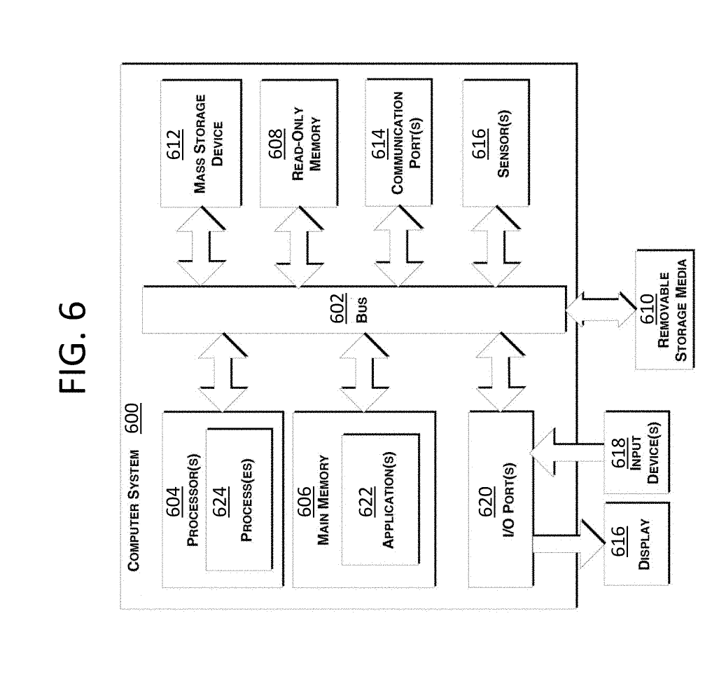

FIG. 6 is a schematic diagram of a computer system 600 upon which embodiments of the present disclosure may be implemented and carried out.

According to the present example, the computer system 600 includes a bus 602 (i.e., interconnect), one or more processors 604, a main memory 606, read-only memory 608, removable storage media 610, mass storage 612, and one or more communications ports 614. Communication port(s) 614 may be connected to one or more networks (not shown) by way of which the computer system 600 may receive and/or transmit data.

As used herein, a “processor” means one or more microprocessors, central processing units (CPUs), computing devices, microcontrollers, digital signal processors, or like devices or any combination thereof, regardless of their architecture. An apparatus that performs a process can include, e.g., a processor and those devices such as input devices and output devices that are appropriate to perform the process.

Processor(s) 604 can be any known processor, such as, but not limited to, an Intel® Itanium® or Itanium 2® processor(s), AMD® Opteron® or Athlon MP® processor(s), or Motorola® lines of processors, and the like. Communications port(s) 614 can be any of an Ethernet port, a Gigabit port using copper or fiber, or a USB port, and the like. Communications port(s) 614 may be chosen depending on a network such as a Local Area Network (LAN), a Wide Area Network (WAN), or any network to which the computer system 600 connects. The computer system 600 may be in communication with peripheral devices (e.g., display screen 616, input device(s) 618) via Input/Output (I/O) port 620.

Main memory 606 can be Random Access Memory (RAM), or any other dynamic storage device(s) commonly known in the art. Read-only memory (ROM) 608 can be any static storage device(s) such as Programmable Read-Only Memory (PROM) chips for storing static information such as instructions for processor(s) 604. Mass storage 612 can be used to store information and instructions. For example, hard disk drives, an optical disc, an array of disks such as Redundant Array of Independent Disks (RAID), or any other mass storage devices may be used.

Bus 602 communicatively couples processor(s) 604 with the other memory, storage and communications blocks. Bus 602 can be a PCI/PCI-X, SCSI, a Universal Serial Bus (USB) based system bus (or other) depending on the storage devices used, and the like. Removable storage media 610 can be any kind of external storage, including hard-drives, floppy drives, USB drives, Compact Disc-Read Only Memory (CD-ROM), Compact Disc—Re-Writable (CD-RW), Digital Versatile Disk-Read Only Memory (DVD-ROM), etc.

Embodiments herein may be provided as one or more computer program products, which may include a machine-readable medium having stored thereon instructions, which may be used to program a computer (or other electronic devices) to perform a process. As used herein, the term “machine-readable medium” refers to any medium, a plurality of the same, or a combination of different media, which participate in providing data (e.g., instructions, data structures) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random access memory, which typically constitutes the main memory of the computer. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications.

The machine-readable medium may include, but is not limited to, floppy diskettes, optical discs, CD-ROMs, magneto-optical disks, ROMs, RAMs, erasable programmable read-only memories (EPROMs), electrically erasable programmable read-only memories (EEPROMs), magnetic or optical cards, flash memory, or other type of media/machine-readable medium suitable for storing electronic instructions. Moreover, embodiments herein may also be downloaded as a computer program product, wherein the program may be transferred from a remote computer to a requesting computer by way of data signals embodied in a carrier wave or other propagation medium via a communication link (e.g., modem or network connection).

Various forms of computer readable media may be involved in carrying data (e.g. sequences of instructions) to a processor. For example, data may be (i) delivered from RAM to a processor; (ii) carried over a wireless transmission medium; (iii) formatted and/or transmitted according to numerous formats, standards or protocols; and/or (iv) encrypted in any of a variety of ways well known in the art.

A computer-readable medium can store (in any appropriate format) those program elements which are appropriate to perform the methods.

As shown, main memory 606 is encoded with application(s) 622 that support(s) the functionality as discussed herein (the application(s) 622 may be an application(s) that provides some or all of the functionality of the services/mechanisms described herein. Application(s) 622 (and/or other resources as described herein) can be embodied as software code such as data and/or logic instructions (e.g., code stored in the memory or on another computer readable medium such as a disk) that supports processing functionality according to different embodiments described herein.

During operation of one embodiment, processor(s) 604 accesses main memory 606 via the use of bus 602 in order to launch, run, execute, interpret or otherwise perform the logic instructions of the application(s) 622. Execution of application(s) 622 produces processing functionality of the service related to the application(s). In other words, the process(es) 624 represent one or more portions of the application(s) 622 performing within or upon the processor(s) 604 in the computer system 600.

It should be noted that, in addition to the process(es) 624 that carries (carry) out operations as discussed herein, other embodiments herein include the application 622 itself (i.e., the un-executed or non-performing logic instructions and/or data). The application 622 may be stored on a computer readable medium (e.g., a repository) such as a disk or in an optical medium. According to other embodiments, the application 622 can also be stored in a memory type system such as in firmware, read only memory (ROM), or, as in this example, as executable code within the main memory 606 (e.g., within Random Access Memory or RAM). For example, application(s) 622 may also be stored in removable storage media 610, read-only memory 608, and/or mass storage device 612.

Those of ordinary skill in the art will understand that the computer system 600 can include other processes and/or software and hardware components, such as an operating system that controls allocation and use of hardware resources.

As discussed herein, embodiments of the present invention include various steps or operations. A variety of these steps may be performed by hardware components or may be embodied in machine-executable instructions, which may be used to cause a general-purpose or special-purpose processor programmed with the instructions to perform the operations. Alternatively, the steps may be performed by a combination of hardware, software, and/or firmware. The term “module” refers to a self-contained functional component, which can include hardware, software, firmware or any combination thereof.

One of ordinary skill in the art will readily appreciate and understand, upon reading this description, that embodiments of an apparatus may include a computer/computing device operable to perform some (but not necessarily all) of the described process.

Embodiments of a computer-readable medium storing a program or data structure include a computer-readable medium storing a program that, when executed, can cause a processor to perform some (but not necessarily all) of the described process.

Where a process is described herein, those of ordinary skill in the art will appreciate that the process may operate without any user intervention. In another embodiment, the process includes some human intervention (e.g., a step is performed by or with the assistance of a human).

As used herein, including in the claims, the phrase “at least some” means “one or more,” and includes the case of only one. Thus, e.g., the phrase “at least some ABCs” means “one or more ABCs”, and includes the case of only one ABC.

As used herein, including in the claims, term “at least one” should be understood as meaning “one or more”, and therefore includes both embodiments that include one or multiple components. Furthermore, dependent claims that refer to independent claims that describe features with “at least one” have the same meaning, both when the feature is referred to as “the” and “the at least one”.

As used in this description, the term “portion” means some or all. So, for example, “A portion of X” may include some of “X” or all of “X”. In the context of a conversation, the term “portion” means some or all of the conversation.

As used herein, including in the claims, the phrase “using” means “using at least,” and is not exclusive. Thus, e.g., the phrase “using X” means “using at least X.” Unless specifically stated by use of the word “only”, the phrase “using X” does not mean “using only X.”

As used herein, including in the claims, the phrase “based on” means “based in part on” or “based, at least in part, on,” and is not exclusive. Thus, e.g., the phrase “based on factor X” means “based in part on factor X” or “based, at least in part, on factor X.” Unless specifically stated by use of the word “only”, the phrase “based on X” does not mean “based only on X.”

In general, as used herein, including in the claims, unless the word “only” is specifically used in a phrase, it should not be read into that phrase.

As used herein, including in the claims, the phrase “distinct” means “at least partially distinct.” Unless specifically stated, distinct does not mean fully distinct. Thus, e.g., the phrase, “X is distinct from Y” means that “X is at least partially distinct from Y,” and does not mean that “X is fully distinct from Y.” Thus, as used herein, including in the claims, the phrase “X is distinct from Y” means that X differs from Y in at least some way.

It should be appreciated that the words “first,” “second,” and so on, in the description and claims, are used to distinguish or identify, and not to show a serial or numerical limitation. Similarly, letter labels (e.g., “(A)”, “(B)”, “(C)”, and so on, or “(a)”, “(b)”, and so on) and/or numbers (e.g., “(i)”, “(ii)”, and so on) are used to assist in readability and to help distinguish and/or identify, and are not intended to be otherwise limiting or to impose or imply any serial or numerical limitations or orderings. Similarly, words such as “particular,” “specific,” “certain,” and “given,” in the description and claims, if used, are to distinguish or identify, and are not intended to be otherwise limiting.

As used herein, including in the claims, the terms “multiple” and “plurality” mean “two or more,” and include the case of “two.” Thus, e.g., the phrase “multiple ABCs,” means “two or more ABCs,” and includes “two ABCs.” Similarly, e.g., the phrase “multiple PQRs,” means “two or more PQRs,” and includes “two PQRs.”

The present invention also covers the exact terms, features, values and ranges, etc. in case these terms, features, values and ranges etc. are used in conjunction with terms such as about, around, generally, substantially, essentially, at least etc. (i.e., “about 3” or “approximately 3” shall also cover exactly 3 or “substantially constant” shall also cover exactly constant).

As used herein, including in the claims, singular forms of terms are to be construed as also including the plural form and vice versa, unless the context indicates otherwise. Thus, it should be noted that as used herein, the singular forms “a,” “an,” and “the” include plural references unless the context clearly dictates otherwise.

Throughout the description and claims, the terms “comprise”, “including”, “having”, and “contain” and their variations should be understood as meaning “including but not limited to”, and are not intended to exclude other components unless specifically so stated.

It will be appreciated that variations to the embodiments of the invention can be made while still falling within the scope of the invention. Alternative features serving the same, equivalent or similar purpose can replace features disclosed in the specification, unless stated otherwise. Thus, unless stated otherwise, each feature disclosed represents one example of a generic series of equivalent or similar features.

The present invention also covers the exact terms, features, values and ranges, etc. in case these terms, features, values and ranges etc. are used in conjunction with terms such as about, around, generally, substantially, essentially, at least etc. (i.e., “about 3” shall also cover exactly 3 or “substantially constant” shall also cover exactly constant).

Use of exemplary language, such as “for instance”, “such as”, “for example” (“e.g.,”) and the like, is merely intended to better illustrate the invention and does not indicate a limitation on the scope of the invention unless specifically so claimed.

While the invention has been described in connection with what is presently considered to be the most practical and preferred embodiments, it is to be understood that the invention is not to be limited to the disclosed embodiment, but on the contrary, is intended to cover various modifications and equivalent arrangements included within the spirit and scope of the appended claims.

What is claimed is:

1. A computing system comprising:
at least one processor unit;
at least one memory unit coupled with the at least one processor unit;
computer readable instructions embodied in the memory unit and executable by the processor unit, wherein execution of the instructions by the processor unit causes the computing system to perform a method, the method comprising:
(A) receiving information related to at least one unallocated donation;
(B) receiving information related to a first recipient;
(C) providing media over a network;
(D) receiving information related to a first user's interaction with the provided media in (C); and
(E) allocating, based on the information received in (D), at least a portion of the at least one unallocated donation to the first recipient.

2. The computing system of claim 1 wherein the method further comprises:
(F) providing at least one reward to the first user based on the information received in (D).

3. The computing system of claim 1 wherein the method further comprises:
(D)(1) receiving information related to a second user's interaction with the provided media in (C); and
(E)(1) allocating, based on the information received in (D)(1), at least a portion of the at least one unallocated donation to the first recipient.

4. The computing system of claim 3 wherein the method further comprises:
(F)(1) providing at least one reward to the second user based on the information received in (D)(1).

5. The computer system of claim 1 wherein the media provided in (C) is a first video.

6. The computer system of claim 5 wherein the information received in (D) relates to the amount of the first video the first user views.

7. The computer system of claim 1 wherein the method further comprises:
(G) providing a hyperlink to the media;
(H) receiving information related to the first user's sharing of the hyperlink;
(I) allocating, based on the information received in (H), at least a portion of the at least one unallocated donation to the first recipient.

8. The computing system of claim 7 wherein the method further comprises:
(J) providing at least one reward to the first user based on the information received in (H).

9. The computer system of claim 1 wherein the method further comprises:
(K) receiving information related to a third user's interaction with the provided media via the shared hyperlink in (H);
(L) allocating, based on the information received in (K), at least a portion of the at least one unallocated donation to the first recipient.

10. The computing system of claim 9 wherein the method further comprises:
(J) providing at least one reward to the first user based on the information received in (K).

11. The computer system of claim 1 wherein the method further comprises:
(E)(1) displaying the at least a portion of the at least one unallocated donation.

12. The computer system of claim 1 wherein the media provided in (C) is a first augmented reality object.

13. The computer system of claim 12 wherein the information received in (D) relates to the first user's viewing of the first augmented reality object.

14. The computer system of claim 1 wherein the media provided in (C) is a first virtual reality environment.

15. The computer system of claim 14 wherein the information received in (D) relates to the first user's experiencing of the first virtual reality environment.

16. A non-transitory computer readable medium having computer readable instructions embedded therein, the computer readable instructions being configured to implement a method when executed, the method comprising:
(A) receiving information related to at least one unallocated donation;
(B) receiving information related to a first recipient;
(C) providing media over a network;
(D) receiving information related to a first user's interaction with the provided media in (C); and
(E) allocating, based on the information received in (D), at least a portion of the at least one unallocated donation to the first recipient.

17. The computing system of claim 16 wherein the method further comprises:
(F) providing at least one reward to the first user based on the information received in (D).

18. The computer system of claim 16 wherein the method further comprises:
(G) providing a hyperlink to the media;
(H) receiving information related to the first user's sharing of the hyperlink;
(I) allocating, based on the information received in (H), at least a portion of the at least one unallocated donation to the first recipient.

19. The computing system of claim 18 wherein the method further comprises:
(J) providing at least one reward to the first user based on the information received in (H).

20. The computer system of claim 16 wherein the method further comprises:
(K) receiving information related to a second user's interaction with the provided media via the shared hyperlink in (H);
(L) allocating, based on the information received in (K), at least a portion of the at least one unallocated donation to the first recipient.
